(19) United States
(12) Patent Application Publication
(10) Pub. No.: US 2026/0184209 A1
(43) Pub. Date: Jul. 2, 2026

(54) POSITIONING METHOD FOR RECHARGING, SELF-MOVING EQUIPMENT AND BODY POSITIONING SYSTEM

(71) Applicant: SHENZHEN HANYANG TECHNOLOGY CO., LTD., Shenzhen, Guangdong (CN)

(72) Inventors: Yang Huang, Shenzhen, Guangdong (CN); Taotao Zhu, Shenzhen, Guangdong (CN); Yongqi Song, Shenzhen, Guangdong (CN); Baofeng Han, Shenzhen, Guangdong (CN); Chuwei Zhang, Shenzhen, Guangdong (CN); Yufan Chen, Shenzhen, Guangdong (CN)

(21) Appl. No.: 18/728,085

(22) PCT Filed: Nov. 20, 2023
(86) PCT No.: PCT/CN2023/132587

§ 371 Date: Jul. 11, 2024

(30) Foreign Application Priority Data
Oct. 20, 2023 (CN) 202311371360.8
Oct. 20, 2023 (CN) 202322839738.4

(51) Int. Cl. B60L 53/36; B60L 53/124; B60L 53/31; B60L 53/38; G01B 7/00

(52) U.S. Cl. CPC B60L 53/36; B60L 53/124; B60L 53/31; B60L 53/38; G01B 7/003; B60L 2200/40

(57) ABSTRACT

The invention relates to a positioning method for recharging, a self-moving equipment and a body positioning system, which are applied to the technical field of positioning for recharging self-moving equipment. A positioning inductance is generated by induction between the self-moving equipment and a target charging pile, and the self-moving equipment is provided with a magnetic induction sensor. The positioning method for recharging comprises: acquiring the positioning inductance on a recharging path through the magnetic induction sensor, the recharging path refers to a path that the self-moving equipment moves to the target charging pile; and positioning the self-moving equipment for recharging according to the positioning inductance.

This application claims the priority of China patent application No. 202311371360.8, filed on Oct. 20, 2023, titled “Positioning method for recharging, system, self-moving equipment and readable storage media”, the contents of which are incorporated herein by reference in their entirety.

This application claims the priority of China patent application No. 202322839738.4, filed on Oct. 20, 2023, titled “Body positioning system and body charging equipment”, the contents of which are incorporated herein by reference in their entirety.

### TECHNICAL FIELD

The invention relates to the technical field of positioning for recharging self-moving equipment, in particular to a positioning method for recharging, a self-moving equipment and a body positioning system.

### BACKGROUND

When a robot performs positioning for recharging, it usually adopts infrared positioning and laser positioning, and calculates the positioning information by receiving the reflected signal. However, the inventor found that the reflected signal is easily affected by terrain obstruction or environmental light. For example, when encountering strong sunlight or strong reflection of snow surface, the positioning methods such as infrared positioning and laser positioning may fail, resulting in decreased positioning accuracy and a large positioning error. Therefore, the current positioning accuracy for recharging self-moving equipment is low.

The above contents are merely provided for the understanding of the technical solutions of this application. It does not imply that the above contents are prior art.

### SUMMARY OF THE INVENTION

The main purpose of the application is to provide a positioning method for recharging, a self-moving equipment and a body positioning system, aiming at solving the technical problems that the existing recharging positioning technology is easily influenced by the environment and has low positioning accuracy.

In order to achieve the above purpose, the application provides a positioning method for recharging, which is applied to a self-moving equipment; a positioning inductance is generated by induction between the self-moving equipment and a target charging pile, and the self-moving equipment is provided with a magnetic induction sensor, wherein the positioning method for recharging comprises the following steps:
acquiring the positioning inductance on a recharging path through the magnetic induction sensor, the recharging path refers to a path that the self-moving equipment moves to the target charging pile; and
positioning the self-moving equipment for recharging according to the positioning inductance.

The application also provides a self-moving equipment, which comprises a head, a body, a recharging positioning equipment, a memory, a processor and a recharging positioning program for the self-moving equipment stored in the memory and executable on the processor, wherein the head is detachably connected to the body, the recharging positioning equipment, the memory and the processor are arranged on the body, and the recharging positioning program for the self-moving equipment is configured to realize the positioning method for recharging described above.

The application also provides a body positioning system, which comprises the above self-moving equipment, and the self-moving equipment comprises the head and the body; the body is provided with an induction assembly;
the body positioning system further comprises a positioning device, wherein the positioning device comprises a base and a coil assembly, and the coil assembly is installed on the base; and
when a position of the induction assembly corresponds to a position of the coil assembly, the induction assembly and the coil assembly are induced to locate a position of the body.

The invention provides a positioning method for recharging, which is applied to a self-moving equipment; a positioning inductance is generated by induction between the self-moving equipment and a target charging pile, and the self-moving equipment is provided with a magnetic induction sensor, wherein the positioning method for recharging comprises: acquiring the positioning inductance on a recharging path through the magnetic induction sensor, the recharging path refers to a path that the self-moving equipment moves to the target charging pile; and positioning the self-moving equipment for recharging according to the positioning inductance. Firstly, the recharging path of the self-moving equipment is determined, then the positioning inductance generated by electromagnetic induction between the self-moving equipment and the target charging pile is collected based on the magnetic induction sensor arranged on the self-moving equipment, and finally the self-moving equipment is positioned for recharging through the positioning inductance. In this way, the purpose of positioning for recharging the self-moving equipment by the target charging pile through electromagnetic induction is achieved. The electromagnetic induction generated when the magnetic induction sensor is close to the induction coil has the characteristics of strong penetrating power and will not be absorbed by water, soil, concrete and other substances, it can still assure accurate positioning results in a complex outdoor environment, therefore, it is not required to calculate positioning information by receiving reflected signals during positioning for recharging. Therefore, the technical problem that “when recharging, the positioning signal is affected by terrain obstruction or environmental light, which makes the calculation result of position coordinates deviate and the positioning accuracy decrease, resulting in mismatch between the positioning result and the charging area of the charging pile” is overcome. Therefore, the recharging positioning accuracy of the self-moving equipment is improved.

According to the body positioning system of the application, the body of the self-moving equipment moves to drive the induction assembly to gradually approach the coil assembly on the base. When the position of induction assembly corresponds to the position of coil assembly, the coil assembly generates a magnetic field, and the induction assembly and coil assembly are electromagnetically induced to locate the position of the body on the base, which improves the positioning accuracy of the body.

Details of one or more embodiments of the application are set forth in the following drawings and descriptions, and other features and advantages of the application will be apparent from the description, drawings and claims.

### BRIEF DESCRIPTION OF THE DRAWINGS

The drawings herein are incorporated into and constitute a part of this specification. Embodiments consistent with this application are shown and together with the description, serve to illustrate the principles of this application.

In order to explain the technical solutions of the embodiments of the present application or the prior art more clearly, the drawings adopted in the descriptions of the present embodiments or the prior art will be briefly introduced below. Obviously, for those of ordinary skill in the art, other drawings may be obtained according to these drawings without creative effort.

FIG. 1 is a flow diagram of a positioning method for recharging provided by Embodiment 1 of the present application.

FIG. 2 is a schematic diagram of the installation positions of the beacon coil and recharging positioning coil on the charging pile according to the positioning method for recharging provided by Embodiment 1 of the present application.

FIG. 3 is a schematic diagram of the recharging action of the self-moving equipment to which the positioning method for recharging provided by Embodiment 1 of the present application is applied.

FIG. 4 is a flow chart of the positioning method for recharging provided by Embodiment 2 of the present application.

FIG. 5 is a schematic diagram of the implementation of the positioning method for recharging provided by Embodiment 2 of the present application.

FIG. 6 is a schematic diagram of the module structure of the positioning system for recharging provided by Embodiment 3 of the present application.

FIG. 7 is a schematic diagram of the equipment structure of the hardware operating environment related to the positioning method for recharging by an embodiment of the present application.

FIG. 8 is a structural schematic diagram of a body positioning system according to an embodiment of the present application.

FIG. 9 is a structural schematic diagram of a body positioning system according to another embodiment of the present application.

FIG. 10 is a structural schematic diagram of a body positioning system according to another embodiment of the present application.

Reference signs in the attached drawings are as follows.

| Reference | | Reference | |
|---|---|---|---|
| sign | Name | sign | Name |
| 100 | Body positioning system | 10 | Housing |
| 20 | Induction assembly | 21 | Receiving plate |
| 211 | First plate | 212 | Second plate |
| 22 | Inductor | 221 | First inductor |
| 222 | Second inductor | 30 | Positioning device |
| 31 | Coil assembly | 311 | Positioning element |
| 312 | Beacon element | 32 | Base |
| 40 | Connecting mechanism | 41 | First connector |
| 42 | Second connector | 43 | Third connector |
| 1 | Head | 2 | Body |

The realization, functional characteristics and advantages of the purpose of this application will be further explained with reference to the attached drawings and examples.

### DETAILED DESCRIPTION OF THE DISCLOSED EMBODIMENTS

In order to make the above objects, features and advantages of this application more clear and easy to understand, the technical solutions of the embodiments will be described clearly and completely with the attached drawings. Obviously, the described embodiments are merely part of the embodiments of this application, not all of them. Based on the embodiments in this application, all other embodiments obtained by those of ordinary skill in the art without creative effort belong to the protection scope of this application.

### Embodiment 1

With the continuous development of science and technology, self-moving equipment are more and more widely used in various application scenarios. Some outdoor mobile robots have appeared for snow removal, grass mowing, leaf blowing and golf ball picking. When self-moving equipment work outdoors for a period of time, it is necessary to search for the location of charging piles for recharging.

In other terms, when the self-moving equipment works outdoors, it would face the situation that it needs to return to the charging pile for recharging. Most of the existing recharging methods are wireless charging, and wireless charging requires high positioning accuracy, so it is necessary to use positioning technology with high positioning accuracy to ensure that the self-moving equipment can realize correct positioning more efficiently.

In order to realize the recharging positioning of self-moving equipment, infrared positioning or radar positioning technology is usually adopted. Both infrared positioning and radar positioning adopt echo ranging method, that is, the distance is acquired by measuring the phase difference of the transmitted signal on the measured distance. Some self-moving equipment also adopt single antenna RTK (Real-time kinematic) system for positioning. In complex environments, such as scenarios with strong reflection of snow and shade, the positioning technology is prone to poor signal or positioning failure.

To sum up, the commonly used positioning technologies are easily affected by the environment, and the positioning results are inaccurate or ineffective, which leads to low positioning accuracy of self-moving equipment in the process of positioning and recharging.

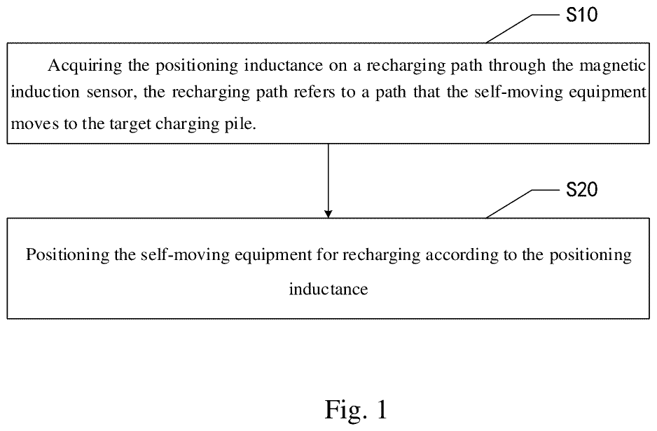

Based on this, Embodiment 1 of the application provides a positioning method for recharging, which is applied to a self-moving equipment, and the self-moving equipment is provided with a magnetic induction sensor. Referring to FIG. 1, the positioning method for recharging comprises the following steps.
Step S10: acquiring the positioning inductance on a recharging path through the magnetic induction sensor, the recharging path refers to a path that the self-moving equipment moves to the target charging pile.
Step S20: positioning the self-moving equipment for recharging according to the positioning inductance.

In this embodiment, it should be noted that there are many ways to start the self-moving equipment to move to the target charging pile for recharging when the self-moving equipment is working outdoors. Specifically, it can be such ways as receiving instructions or starting it autonomously. For example, when the self-moving equipment detects that the power drops to a certain threshold, the recharging function is started autonomously.

In addition, it should be noted that the recharging path is used to characterize the path that the self-moving equipment moves to the target charging pile after the recharging function is turned on and the position of the target charging pile is obtained. When the self-moving equipment moves toward the target charging pile through the recharging path, the positioning inductance on the target charging pile is sensed by the magnetic induction sensor on the self-moving equipment, and the magnetic induction sensor is used for electromagnetic induction and can output the magnetic inductance. The induced positioning inductance is a magnetic induction signal, and the number of magnetic induction sensors may be one or more. The coils included in the coil assembly installed on the target charging pile may specifically be communication coils, beacon coils and recharging positioning coils. And the communication coil is used to realize wireless communication between the self-moving equipment and the target charging pile; the beacon coil is used for the magnetic induction when positioning occurs once with the magnetic induction sensor arranged on the self-moving equipment; and the recharging positioning coil is used for the magnetic induction when positioning occurs twice with the magnetic induction sensor arranged on the self-moving equipment, so as to output the magnetic inductance. Understandably, in order to accurately position the self-moving equipment in complex environment, the electromagnetic induction positioning technology is adopted. The positioning inductance is obtained by the induction of the coil by the magnetic induction sensor, and the position of the magnetic induction sensor is determined by the positioning inductance, so as to determine the position of the self-moving equipment and realize the position of the self-moving equipment.

It can be understood that after the magnetic induction sensor on the self-moving equipment senses the coil on the target charging pile, the self-moving equipment does not need to measure the distance by calculating the phase difference of the signal going back and forth on the measured distance, but can be positioned and recharged by the positioning inductance of the magnetic induction sensor, and the position of the self-moving equipment can be adjusted by the positioning inductance.

As an example, steps S10 to S20 include: detecting the coil on the target charging pile by using the magnetic induction sensor installed on the self-moving equipment, acquiring the positioning inductance on a recharging path through the magnetic induction sensor, the recharging path refers to a path that the self-moving equipment moves to the target charging pile; and positioning the self-moving equipment for recharging according to the positioning inductance; so that the self-moving equipment moves for recharging positioning, and the magnetic induction sensor falls into the recharging positioning coil.

The invention provides a positioning method for recharging, which comprises the following steps: when a self-moving equipment needs recharging and moves to a target charging pile, the magnetic induction sensor installed on the self-moving equipment senses a positioning inductance on the target charging pile; the self-moving equipment is positioned and recharged according to the positioning inductance. According to the embodiment of the invention, the magnetic induction sensor and the coil are used for induction, the magnetic induction signal generated by induction is measured, and the position of the self-moving equipment is determined and adjusted according to the magnetic induction signal, so as to position the self-moving equipment for recharging. The characteristic that the magnetic induction signal is not interfered by water, soil, rocks and the like is utilized, so that the self-moving equipment does not need to be positioned by echo ranging during positioning and recharging, and the influence of environmental factors and the like on the positioning effect is avoided. In addition, because the positioning inductance is directly determined, the positioning result is controlled within the precision requirement range. Therefore, the recharging positioning accuracy of the self-moving equipment is improved.

The positioning inductance comprises a preset positioning inductance and a recharging positioning inductance, and the step of positioning the self-moving equipment for recharging according to the positioning inductance comprises the following steps.
Step A10: detecting whether the beacon that the self-moving equipment currently located is a middle beacon, and the currently-located beacon is arranged in the target charging pile.
Step A20: if the currently-located beacon is the middle beacon, positioning the self-moving equipment for recharging according to the recharging positioning inductance.
Step A30: if the currently-located beacon is not the middle beacon, the self-moving equipment moves according to the preset positioning inductance until the self-moving equipment arrives at the middle beacon.

In this embodiment, it should be noted that the preset positioning inductance is used to determine the beacon position of the self-moving equipment, that is, to preliminarily determine the position of the self-moving equipment on the charging pile. For example, the preset positioning inductance may be a magnetic inductance between the magnetic induction sensor on the self-moving equipment and the beacon, and the recharging positioning inductance may be used to determine that the magnetic induction sensor on the self-moving equipment has completely fallen into the recharging positioning coil on the charging pile.

In addition, it should be noted that a beacon (i.e. beacon element 312 mentioned later) may be arranged on the target charging pile, and the beacon is used to assist the self-moving equipment to perform positioning for recharging more quickly. The magnetic induction sensor on the self-moving equipment detects the currently-located beacon of the self-moving equipment according to the relative position relationship between the magnetic induction sensor and the beacon. The beacon is arranged on the target charging pile. There may be one or more beacons. When there are a plurality of beacons, the beacons are arranged in parallel and at intervals on the base of the target charging pile. The number of the currently-located beacons may be 3. The beacon in the middle of the three beacons is called middle beacon. The middle beacon and the recharging positioning coil are on the same horizontal line, and the middle beacon coil is parallel to the bottom of the recharging positioning coil. Therefore, when the self-moving equipment moves to the position where the beacon is located, it can translate in the direction of the recharging positioning coil and induce the recharging positioning coil, and the beacon that falls into the magnetic induction sensor most or the beacon where the magnetic induction sensor is currently located can be used as the currently-located beacon. In addition, there may be 3 magnetic induction sensors, for example, when two of them are located above the middle beacon, it can be determined that the currently-located beacon of the self-moving equipment is a middle beacon, and the magnetic induction sensor may also be located between adjacent beacons.

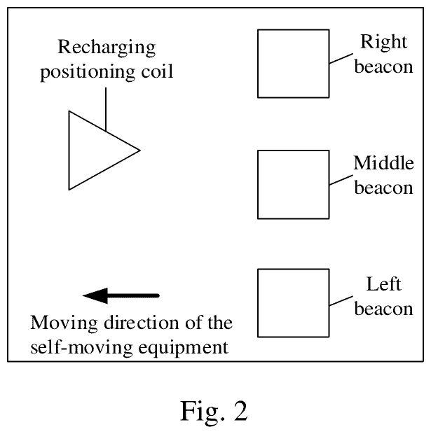

In other embodiment, in order to help understand the installation positions of the beacon coil and the recharging positioning coil on the charging pile, please refer to FIG. 2, which provides a schematic diagram of the installation positions of the beacon coil and the recharging positioning coil on the charging pile. Three beacons, namely the left beacon, the middle beacon and the right beacon, are installed on the charging pile, and a triangular recharging positioning coil is installed. The triangular recharging positioning coil and the middle beacon coil are installed on the same horizontal line, and the bottom of the triangular recharging positioning coil is parallel to the middle beacon coil.

It should be noted that there is a correlation between the positions of beacons. When the self-moving equipment is located on different beacons, the induced preset positioning inductances are different, and the sizes of the preset positioning inductances are related. Therefore, when the self-moving equipment is located on a position other than middle beacon, the self-moving equipment can move according to the position relationship between beacons and the preset positioning inductances, so that the magnetic induction sensor on the self-moving equipment is located in the middle beacon coil.

As an example, steps A10 to A30 include: detecting whether the beacon that the self-moving equipment currently located is a middle beacon, and the currently-located beacon is arranged in the target charging pile; if the currently-located beacon is the middle beacon, positioning the self-moving equipment for recharging according to the recharging positioning inductance; if the currently-located beacon is not the middle beacon, the self-moving equipment moves according to the preset positioning inductance until the self-moving equipment arrives at the middle beacon.

Wherein, the preset positioning inductance includes a periodic signal, and the duty ratio of the high level is obtained by calculating the time occupied by the high level in a preset period. The magnetic induction sensor detects different beacons, the obtained duty ratios are different, and the different duty ratios may be realized by a switch circuit, therefore the currently-located beacon of the self-moving equipment may also be determined according to the different duty ratios, so as to improve the accuracy of determining the currently-located beacon of the self-moving equipment. The specific steps of detecting whether the currently-located beacon is the middle beacon with the based on the duty ratio corresponding to the preset positioning inductance may be as follows: according to the duty ratio, the currently-located beacon of the self-moving equipment is determined, that is, when the magnetic induction sensor on the self-moving equipment moves to the beacon position, the preset positioning inductance is detected, and the duty ratio of the high level in the preset positioning inductance is calculated, so the currently-located beacon of the self-moving equipment is determined according to the calculated duty ratio.

The step of positioning the self-moving equipment for recharging according to the positioning inductance comprises the following steps:
Step C10: detecting whether the positioning inductance reaches a preset magnetic induction threshold.
Step C20: if yes, determining that the positioning of the self-moving equipment for recharging is complete.
Step C30: if not, adjusting a position of the self-moving equipment to obtain an adjusted position.
Step C40: taking a magnetic inductance induced by the magnetic induction sensor at the adjusted position as the positioning inductance, and returning to execute the step: detecting whether the positioning inductance reaches a preset magnetic induction threshold.

In this embodiment, it should be noted that the recharging positioning inductance is the inductance of the recharging positioning coil on the charging pile by the magnetic induction sensor on the self-moving equipment. The recharging positioning coil may be, for example, a triangular coil, there may be three magnetic induction sensors. According to the sizes the recharging positioning inductances detected by the three magnetic induction sensors and the preset magnetic induction threshold, the position of the self-moving equipment is moved. When the recharging positioning inductance reaches the preset magnetic induction threshold, it indicates that all the magnetic induction sensors fall into the recharging positioning coil. At this point, the self-moving equipment can be stopped, and the positioning for recharging is completed, and a charging signal can be sent to the charging module of the self-moving equipment.

In addition, it should be noted that in order to determine the position of the self-moving equipment and the recharging positioning coil more accurately, a magnetic induction threshold is preset for the magnetic induction sensor. For example, in a triangular coil, due to the triangular shape distribution, the magnetic field intensities of three sides are the same, so the magnetic inductances of the magnetic induction sensors on three sides of the triangle are the same, so that the preset magnetic induction threshold is also the same. When the magnetic induction sensors on the mobile equipment sense the recharging positioning coil from various angles, the sensed magnetic inductances are the same.

Understandably, when the recharging positioning inductance reaches the preset magnetic induction threshold, the magnetic induction sensor falls into the recharging positioning coil, and the positioning for recharging is considered complete. At this point, the distance between the charging module on the self-moving equipment and the charging module on the charging pile is within the error range of positioning for recharging, and charging can be performed.

As an example, steps C10 to C40 include: moving the position of the self-moving equipment according to the relationship between the recharging positioning inductance and the preset magnetic induction threshold detected by the magnetic induction sensor when the self-moving equipment performs positioning for recharging. The magnetic fields on three sides are the same in the triangular coil. Therefore, when the three magnetic induction sensors on the self-moving equipment all have the same recharging positioning inductances, it indicates that all the magnetic induction sensors are located in the triangular coil, and the positioning for recharging the self-moving equipment is completed.

Before the step of acquiring the positioning inductance on a recharging path through the magnetic induction sensor, the positioning method for recharging further comprises the following steps.
Step D10: detecting whether a first obstacle exists between the target charging pile and the self-moving equipment through a preset sensor in the self-moving equipment.
Step D20: if the first obstacle exists, when detecting that the first obstacle is a movable obstacle, determining whether to move the movable obstacle.
Step D30: if the first obstacle does not exist, controlling the self-moving equipment to move to a first preset position.
Step D40: detecting whether a second obstacle exists on a recharging positioning surface of the target charging pile at the first preset position.
Step D50: if the second obstacle exists, cleaning the second obstacle, and after the cleaning is completed, determining whether the recharging positioning surface meets recharging positioning conditions by performing detection on the recharging positioning surface again.

In this embodiment, it should be noted that the first obstacle refers to the obstacle between the self-moving equipment and the target charging pile, and the second obstacle refers to the obstacle on the recharging positioning surface of the target charging pile. For example, the first obstacle may be obstacles such as cartons, wood blocks and stone piles, and the second obstacle may be obstacles such as snow and leaves.

In addition, it should be noted that the first preset position indicates the self-moving equipment starts the recharging function, obtains the position of the target charging pile through the preset position module installed on the self-moving equipment, stops moving and detects the positioning inductance on the target charging pile after moving to the target charging pile. The preset position module may be an RTK module, and the distance between the self-moving equipment and the target charging pile when the self-moving equipment stops moving, may be e.g., 1 m, 2 m or 3 m, etc. When the self-moving equipment moves to the first preset position corresponding to the target charging pile, the self-moving equipment stops moving and detects whether there is a first obstacle between the self-moving equipment and the target charging pile through the preset sensor in the self-moving equipment, the preset sensor in the self-moving equipment may be a camera. When there is a first obstacle, the type of the first obstacle is detected, which may be a movable obstacle or an immovable obstacle. If the first obstacle is detected as a movable obstacle, the first obstacle is moved to a direction away from the charging pile, which may be the opposite direction of the self-moving equipment and the charging pile. If the first obstacle is an immovable obstacle, it is moved to the target charging pile according to the identified first obstacle direction. In addition, after the first obstacle is determined to be a movable obstacle, whether to move the movable obstacle may be determined by itself. If it is determined to move the movable obstacle, it may be moved with reference to the following contents: adjusting the back distance from the mobile equipment, lowering the head of the mobile equipment to the ground, and moving the movable obstacle away from the charging pile.

In addition, it should be noted that when there is no first obstacle between the self-moving equipment and the target charging pile, the recharging positioning surface of the target charging pile is further detected to determine whether there is a second obstacle on the recharging positioning surface. When there is a second obstacle on the recharging positioning surface, the second obstacle would affect the charging effect, so it is necessary to clean the second obstacle. During the cleaning process, the self-moving equipment exits the charging pile and conduct detection for a second time on the recharging positioning surface. It is determined whether the second obstacle still exists on the recharging positioning surface. If yes, the recharging positioning surface is continuously cleaned until it is determined that the second obstacle does not exist on the recharging positioning surface. At this time, it is considered that the recharging positioning surface meets the recharging positioning conditions, and the self-moving equipment can move to the target charging pile to start recharging. The recharging positioning conditions mean that the recharging positioning surface does not have any conditions that affect the positioning for recharging the self-moving equipment.

In addition, it should be noted that the instruction of cleaning the second obstacle from the self-moving equipment may be specifically set by the user according to the detection result of the self-moving equipment on the recharging positioning surface, or may be determined by the self-moving equipment according to the detection result.

As an example, steps D10 to D50 include: detecting whether a first obstacle such as a cardboard box or a stone pile exists between the target charging pile and the self-moving equipment through a preset sensor in the self-moving equipment; if the first obstacle exists, the type of the obstacle is detected, when detecting that the first obstacle is a movable obstacle, determining whether to move the movable obstacle; if it is determined to move the movable obstacle, it is moved away from the charging pile; after the influence of the first obstacle on the recharging positioning of the self-moving equipment is eliminated, the self-moving equipment is moved to a first preset position, controlling the self-moving equipment to move to a first preset position; detecting the recharging positioning surface of the target charging pile at the first preset position, determining whether a second obstacle exists; if the second obstacle exists, cleaning the second obstacle, and exiting the charging pile in the cleaning process; and detecting the recharging positioning surface again to determine whether there is a second obstacle until the interference of the second obstacle on the recharging positioning function is eliminated, so that the self-moving equipment moves to the target charging pile to start positioning for recharging.

The step of detecting whether a second obstacle exists on a recharging positioning surface of the target charging pile at the first preset position comprises the following steps.
Step E10: acquiring real-time body data corresponding to the recharging positioning surface of the target charging pile at the first preset position.
Step E20: extracting historical body data corresponding to the recharging positioning surface, wherein the historical body data refers to the body data of the self-moving equipment when the second obstacle does not exist on the recharging positioning surface.
Step E30: determining whether the second obstacle exists on the recharging positioning surface of the target charging pile by comparing the real-time body data with the historical body data.

In this embodiment, it should be noted that the detection of the second obstacle may be performed by the body data of the self-moving equipment. For example, assuming that the second obstacle is snow, the body data can be collected by the IMU sensor carried by the self-moving equipment, and whether there is snow on the recharging positioning surface can be determined by comparing the body data in different time periods. That is, the sensor installed on the self-moving equipment acquires the body data when the second obstacle does not exist on the recharging positioning surface, and stores it. In the process of recharging, the sensor in the self-moving equipment is used again to obtain the current body data, and compared with the stored body data to determine whether the recharging positioning surface needs to be cleaned. The sensor may be an inertial sensor, for example, and the acquired body data may be the inclination data of the body relative to the recharging positioning surface.

As an example, steps E10 to E30 include: acquiring real-time body data corresponding to the recharging positioning surface of the target charging pile at the first preset position; extracting historical body data corresponding to the recharging positioning surface, wherein the historical body data refers to the body data of the self-moving equipment when the second obstacle does not exist on the recharging positioning surface; and determining whether the second obstacle exists on the recharging positioning surface of the target charging pile by comparing the real-time body data with the historical body data.

The positioning method for recharging further comprises the following steps.
Step F10: acquiring a communication situation between the self-moving equipment and the target charging pile.
Step F20: if the communication situation is abnormal, acquiring the positioning inductance on the recharging path through the magnetic induction sensor after the self-moving equipment is located at the first preset position, and determining whether the target charging pile has moved.
Step F30: if it is determined that the target charging pile has moved, controlling the self-moving equipment to move to a second preset position where the preset charging pile is currently located.

In this embodiment, it should be noted that before the self-moving equipment moves to the first preset position of the target charging pile, the communication between the self-moving equipment and the target charging pile is first determined, and according to the judgment result of the communication situation, it is determined whether to move the self-moving equipment for recharging positioning. For example, when the communication between the self-moving equipment and the target charging pile is normal, it only needs to directly control the self-moving equipment to move to the first preset position and perform inductive charging. When the communication between the self-moving equipment and the target charging pile is abnormal, the self-moving equipment is first controlled to move to the first preset position, and whether the target charging pile has moved is determined according to the induction based on the positioning inductance, that is, the beacon on the target charging pile is induced by the magnetic induction sensor to determine whether the positioning inductance can be sensed, and if the magnetic induction sensor cannot sense the positioning inductance, it is determined that the target charging pile has moved; if the magnetic induction sensor can sense the positioning inductance, electromagnetic induction can be performed between the magnetic induction sensor and the target charging pile, and after it is determined that the target charging pile has moved, the self-moving equipment can re-acquire the second preset position of the preset charging pile. The second preset position may be the position of the target charging pile searched by the self-moving equipment, or the position of the target charging pile set by the user by feeding back the information that the target charging pile is not in the preset position to the user terminal. The preset charging pile may be a target charging pile or an alternative charging pile. When the preset charging pile is the target charging pile, the positioning for recharging may be performed by requesting the latest position of the target charging pile from the user terminal. When the preset charging pile is the alternative charging pile, it may be communicated with the alternative charging pile, and the alternative charging pile can send the third preset position to the self-moving equipment, or the positioning for recharging may be performed by requesting the third preset position of the alternative charging pile from the user terminal.

In addition, it should be noted that there is wireless communication between the self-moving equipment and the target charging pile, and the wireless communication has a preset communication range, so the communication situation between the self-moving equipment and the target charging pile can be detected. “Communication is normal” may specifically refer to that the self-moving equipment can search for the location of the target charging pile within the preset communication range; “Communication is abnormal” may specifically refer to the situation that the self-mobile device cannot find the location of the target charging pile within the preset communication range due to communication interference, communication module problems or too long communication distance. Therefore, when the magnetic induction sensor cannot sense the positioning inductance at the first preset position, it indicates that the position of the target charging pile has moved. At this time, the user can reset the position of the target charging pile or establish communication with the alternative charging pile.

In other embodiment, the position of the alternative charging pile may be determined by obtaining the coordinates of the current self-moving equipment and the coordinates of the charging pile through the positioning module on the self-moving equipment.

In addition, it should be noted that after the self-moving equipment completes recharging every time, it can be corrected by resetting the position of the current charging point. When the self-moving equipment needs recharging again, it will move to the last position of the charging pile, so as to improve the recharging efficiency and accuracy.

As an example, steps F10 to F30 include: acquiring a communication situation between the self-moving equipment and the target charging pile; if the communication situation is abnormal, acquiring the positioning inductance on the recharging path through the magnetic induction sensor after the self-moving equipment is located at the first preset position, and determining whether the target charging pile has moved; if it is determined that the target charging pile has moved, controlling the self-moving equipment to move to a second preset position where the preset charging pile is currently located; and the preset charging pile may be an alternative charging pile or the target charging pile.

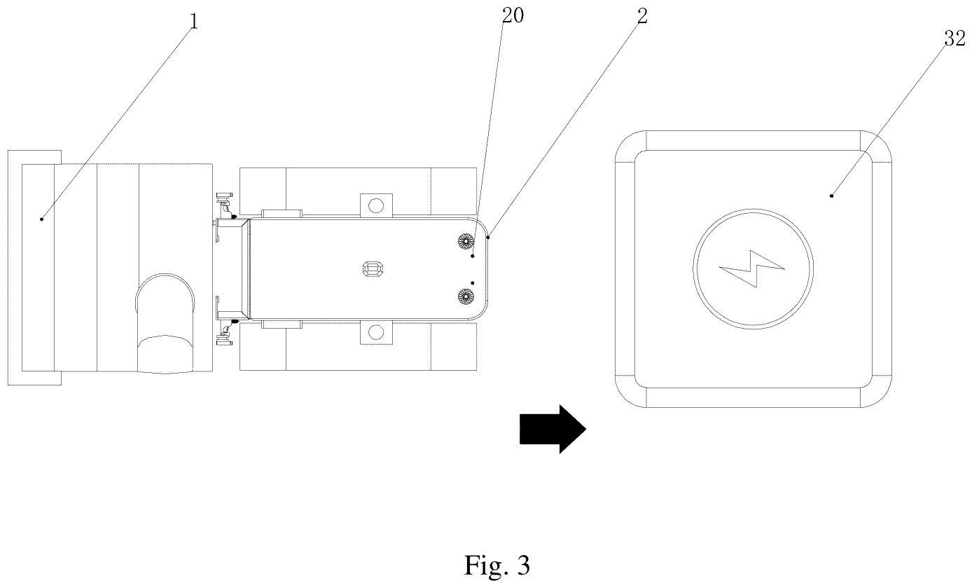

In other embodiment, in order to help understand the technical concept or principle of the application, please refer to FIG. 3, which provides a schematic diagram of the recharging action of the self-moving equipment to which the positioning method for recharging is applied. For example, the self-moving equipment includes a head, a body and a magnetic induction sensor. When the self-moving equipment reaches the target charging pile for charging, the self-moving equipment moves to the target charging pile in a backward way along the direction indicated by the arrow in the figure, and the charging pile is induced by the magnetic induction sensor installed in the body to obtain the positioning inductance.

### Embodiment 2

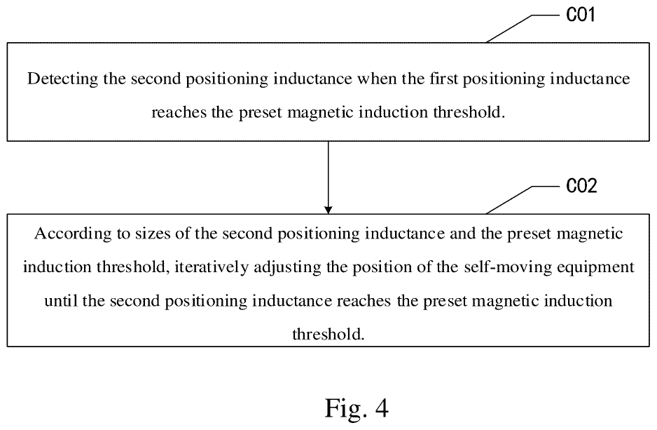

Based on Embodiment 1 of the present application, in another embodiment of the present application, the same or similar contents as the above-mentioned Embodiment 1 can be referred to the above description, and will not be repeated in the following. On this basis, please refer to FIG. 4, the target charging pile is provided with a coil assembly, and when positions correspond, the magnetic induction sensor and the coil assembly are induced to generate the positioning inductance, wherein the magnetic induction sensor comprises a first magnetic induction sensor and a second magnetic induction sensor, and the first magnetic induction sensor and the second magnetic induction sensor are distributed in a triangle; the positioning inductance comprises a first positioning inductance induced by the first magnetic induction sensor and a second positioning inductance induced by the second magnetic induction sensor; the step of positioning the self-moving equipment for recharging according to the positioning inductance comprises the following steps.
Step C01: detecting the second positioning inductance when the first positioning inductance reaches the preset magnetic induction threshold.
Step C02: according to sizes of the second positioning inductance and the preset magnetic induction threshold, iteratively adjusting the position of the self-moving equipment until the second positioning inductance reaches the preset magnetic induction threshold.

In this embodiment, it should be noted that the target charging pile is provided with a coil assembly, and the induction between the target charging pile and the self-moving equipment can specifically generate the positioning inductance through the induction between the coil assembly and the magnetic induction sensor when the positions correspond. The magnetic induction sensor comprises a first magnetic induction sensor and a second magnetic induction sensor. The first magnetic induction sensor may be composed of two magnetic induction sensors, and the second magnetic induction sensor may be composed of one magnetic induction sensor. The first magnetic induction sensor and the second magnetic induction sensor are distributed in a triangle shape, which is convenient to adapt to the induction between the first magnetic induction sensor and the second magnetic induction sensor and the recharging positioning coil. The recharging positioning coil may be a triangular recharging positioning coil. When positioning for recharging the self-moving equipment according to the positioning inductance, it may only use the first positioning inductance sensed by the first magnetic induction sensor. When the first magnetic induction sensor senses the magnetic field of the recharging positioning coil, and the first positioning inductance is within the preset magnetic induction threshold range, the magnetic inductance of the second positioning inductance is detected from scratch until the second positioning inductance reaches the preset magnetic inductance, thus realizing the accurate positioning for recharging the self-moving equipment.

In addition, it should be noted that the induction range of the magnetic induction sensor diverges around the magnetic induction sensor, so the induction range of the magnetic induction sensor is a circular area.

It can be understood that when both the first magnetic induction sensor and the second magnetic induction sensor are induced with the triangular recharging positioning coil, the induction range of the first magnetic induction sensor is inscribed with an angle of the triangular recharging positioning coil, and the induction range of the second magnetic induction sensor is inscribed with an angle of the triangular recharging positioning coil, thereby completing the accurate positioning of the self-moving equipment.

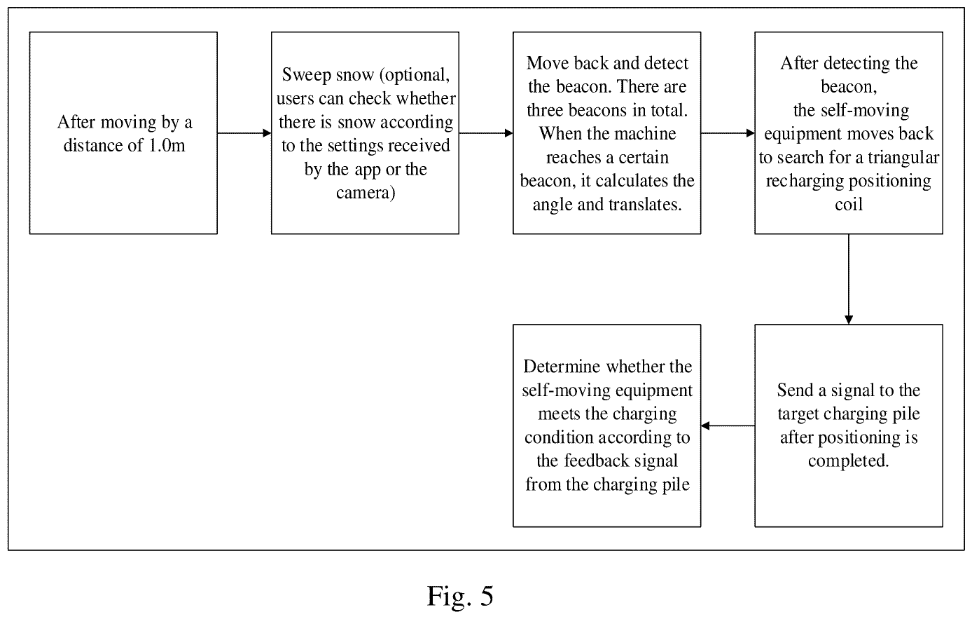

In other embodiment, in order to help understand the technical concept or principle of the application, please refer to FIG. 5, which provides a schematic flow chart of the positioning for recharging.

After the self-moving equipment turns on the recharging function, it moves to the target charging pile until it stops at the first preset position, and it begins to identify whether there is interference from the first obstacle and the second obstacle in the process of positioning for recharging. After removing the interference from the obstacle to the positioning for recharging, it moves to the target charging pile, and induces the coil installed on the target charging pile through the magnetic induction sensor, and the self-moving equipment performs positioning for recharging according to the sensed positioning inductance. Specifically, in a possible implementation mode, when the self-moving equipment moves to a distance of 1.0 m from the target charging pile, obstacles are identified on the recharging positioning surface, and the identification result can be displayed to the user terminal, and the user can choose whether to clean obstacles such as snow according to the identification result, so as to eliminate the influence of obstacles on the recharging positioning function. When it is determined that there are no obstacles on the recharging positioning surface, the self-moving equipment is adjusted to move back for a certain distance. A beacon coil on a target charging pile is detected by a magnetic induction sensor to obtain a preset positioning inductance; when a self-moving equipment moves to a beacon, the duty ratio of a high level in the induced preset positioning inductance is calculated, and the beacon position at this point is determined according to the duty ratio; when the self-moving equipment is not located in the middle beacon, the direction and angle of the self-moving equipment are adjusted to move the self-moving equipment to the middle beacon position; when the self-moving equipment is located in the middle beacon position, the self-moving equipment moves to search for a triangular recharging positioning coil until all magnetic induction sensors on the self-moving equipment are located in the recharging positioning coil, so the positioning for recharging is completed. Then a charging request signal is sent to the charging pile, and determining whether the self-moving equipment meets the charging condition according to the feedback signal from the charging pile.

As an example, steps C01 to C02 include: when the magnetic induction sensor is used for positioning for recharging, because the positions of the first magnetic induction sensor and the second magnetic induction sensor are triangular, and the recharging positioning coil is triangular, the triangular recharging positioning coil may be induced by the magnetic induction sensor on the triangle, and the positioning inductance is determined to reach the preset magnetic induction threshold range, so as to complete positioning. In the positioning process, only two magnetic induction sensors are needed for positioning. When the first positioning inductances sensed by the two magnetic induction sensors reach the preset magnetic induction threshold, the second positioning inductance of the second magnetic induction sensor is further determined, so as to improve the accuracy of positioning for recharging. It is determined that the second magnetic induction sensor generates a second positioning inductance from scratch, and when the second positioning inductance reaches a preset magnetic induction threshold, the self-moving equipment stops moving, thus completing the positioning for recharging.

### Embodiment 3

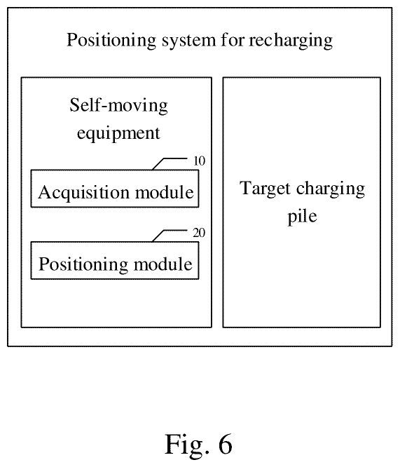

The application also provides a positioning system for recharging. Please refer to FIG. 6. The positioning system for recharging includes a self-moving equipment and a target charging pile, and a positioning inductance is generated by induction between the self-moving equipment and a target charging pile. The self-moving equipment includes a magnetic induction sensor, and the self-moving equipment includes an acquisition module 10 and a positioning module 20.

The acquisition module 10, configured to acquire the positioning inductance on a recharging path through the magnetic induction sensor, and the recharging path refers to the path that the self-moving equipment moves to the target charging pile.

The positioning module 20, configured to position for recharging the self-moving equipment according to the positioning inductance.

In an embodiment, the positioning inductance includes a preset positioning inductance and a recharging positioning inductance, and the positioning module 20 is further configured for:
detecting whether the beacon that the self-moving equipment currently located is a middle beacon, and the currently-located beacon is arranged in the target charging pile;
if the currently-located beacon is the middle beacon, positioning the self-moving equipment for recharging according to the recharging positioning inductance;
if the currently-located beacon is not the middle beacon, the self-moving equipment moves according to the preset positioning inductance until the self-moving equipment arrives at the middle beacon.

In an embodiment, the positioning module 20 is further configured for:
detecting whether the positioning inductance reaches a preset magnetic induction threshold;
if yes, determining that the positioning of the self-moving equipment for recharging is complete;
if not, adjusting a position of the self-moving equipment to obtain an adjusted position;
taking a magnetic inductance induced by the magnetic induction sensor at the adjusted position as the positioning inductance, and returning to execute the step: detecting whether the positioning inductance reaches a preset magnetic induction threshold.

In an embodiment, the target charging pile is provided with a coil assembly, and when positions correspond, the magnetic induction sensor and the coil assembly are induced to generate the positioning inductance, wherein the magnetic induction sensor comprises a first magnetic induction sensor and a second magnetic induction sensor, and the first magnetic induction sensor and the second magnetic induction sensor are distributed in a triangle; the positioning inductance comprises a first positioning inductance induced by the first magnetic induction sensor and a second positioning inductance induced by the second magnetic induction sensor, and the positioning module 20 is further used for:
detecting the second positioning inductance when the first positioning inductance reaches the preset magnetic induction threshold;
according to sizes of the second positioning inductance and the preset magnetic induction threshold, iteratively adjusting the position of the self-moving equipment until the second positioning inductance reaches the preset magnetic induction threshold.

In an embodiment, the self-moving equipment further comprises a determination module, and the determination module is used for:
detecting whether a first obstacle exists between the target charging pile and the self-moving equipment through a preset sensor in the self-moving equipment;
if the first obstacle exists, when detecting that the first obstacle is a movable obstacle, determining whether to move the movable obstacle;
if the first obstacle does not exist, controlling the self-moving equipment to move to a first preset position;
detecting whether a second obstacle exists on a recharging positioning surface of the target charging pile at the first preset position;
if the second obstacle exists, cleaning the second obstacle, and after the cleaning is completed, determining whether the recharging positioning surface meets recharging positioning conditions by performing detection on the recharging positioning surface again.

In an embodiment, the self-moving equipment further comprises a detection module, and the detection module is used for:
acquiring real-time body data corresponding to the recharging positioning surface of the target charging pile at the first preset position;
extracting historical body data corresponding to the recharging positioning surface, wherein the historical body data refers to the body data of the self-moving equipment when the second obstacle does not exist on the recharging positioning surface; and
determining whether the second obstacle exists on the recharging positioning surface of the target charging pile by comparing the real-time body data with the historical body data.

In an embodiment, the self-moving equipment further comprises a control module, and the control module is used for:
acquiring a communication situation between the self-moving equipment and the target charging pile;
if the communication situation is abnormal, acquiring the positioning inductance on the recharging path through the magnetic induction sensor after the self-moving equipment is located at the first preset position, and determining whether the target charging pile has moved;
if it is determined that the target charging pile has moved, controlling the self-moving equipment to move to a second preset position where the preset charging pile is currently located.

The positioning system for recharging provided by this application adopts the positioning method for recharging in the above-mentioned Embodiment 1 or Embodiment 2, which can solve the technical problem of large positioning error in the recharging positioning process for the existing self-moving equipment, so that the recharging positioning accuracy of the self-moving equipment will not be reduced. Compared with the prior art, the beneficial effects of the positioning system for recharging provided by the embodiments of the application are the same as those of the positioning method for recharging provided by the above embodiments, and other technical features of the positioning system for recharging are the same as those disclosed by the method of the above embodiments, so they are not repeated here.

### Embodiment 4

The application also provides a self-moving equipment, which comprises a head, a body, a recharging positioning equipment, a memory, a processor and a recharging positioning program for the self-moving equipment stored in the memory and executable on the processor, wherein the head is detachably connected to the body, the recharging positioning equipment, the memory and the processor are arranged on the body, and the recharging positioning program for the self-moving equipment is configured to realize the positioning method for recharging described above.

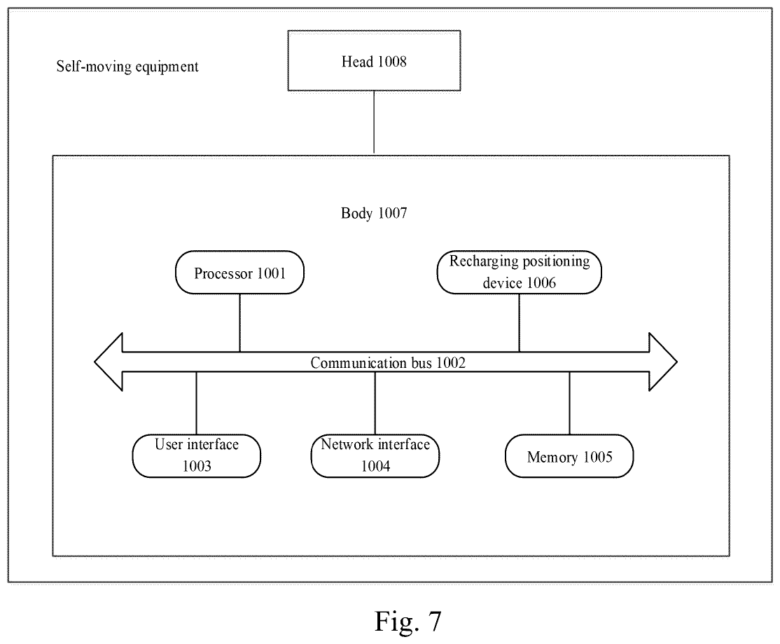

As shown in FIG. 7, the self-moving equipment may include a processor 1001, such as a Central Processing Unit (CPU), a communication bus 1002, a user interface 1003, a network interface 1004, a memory 1005, a recharging positioning device 1006, a body 1007 and a head 1008. The communication bus 1002 is used to realize connection communication between these components. The user interface 1003 may include a display and an input unit such as a keyboard, and the optional user interface 1003 may also include a standard wired interface and a wireless interface. The network interface 1004 may optionally include a standard wired interface and a wireless interface (such as a WIreless-FIdelity (WI-FI) interface). The memory 1005 may be a high-speed Random Access Memory (RAM) or a stable Non-Volatile Memory (NVM), such as a disk memory. The memory 1005 may alternatively be a storage device, separate from the aforementioned processor 1001. The recharging positioning device 1006 may include a magnetic induction sensor. The recharging positioning device 1006 may alternatively be a recharging positioning device, separate from the aforementioned processor 1001. The head 1008 is detachably connected to the body 1007, processor 1001, communication bus 1002, user interface 1003, network interface 1004, memory 1005, and recharging positioning device 1006, and is arranged in the body 1007.

It can be understood by those skilled in the art that the structure shown in FIG. 7 does not constitute a limitation on the self-moving equipment, and may include more or less components than shown, or combine some components, or have different component arrangements.

As shown in FIG. 7, the memory 1005 as a storage medium may include an operating system, a data storage module, a network communication module, a user interface module and a recharging positioning program.

For the self-moving equipment shown in FIG. 7, the network interface 1004 is mainly used for data communication with other devices. The user interface 1003 is mainly used for data interaction with users. The processor 1001, memory 1005 and recharging positioning device 1006 in the self-moving equipment may be arranged in the self-moving equipment, and the self-moving equipment calls the recharging positioning program stored in the memory 1005 through the processor 1001 to control the recharging positioning device 1006 to execute the positioning method for recharging provided by the embodiments of the application.

The self-moving equipment provided by this application can solve the technical problem of large positioning error in the recharging positioning process for the existing self-moving equipment, so that the recharging positioning accuracy of the self-moving equipment will not be reduced. Compared with the prior art, the beneficial effects of the computer-readable storage medium provided by the embodiment of the present application are the same as those of the positioning method for recharging provided by Embodiment 1 or Embodiment 2, and are not repeated here.

It should be understood that various parts of the present disclosure may be implemented in hardware, software, firmware, or a combination thereof. In the description of the above embodiments, specific features, structures, materials or characteristics may be combined in any one or more embodiments or examples in a suitable way.

The above is only a specific implementation of this application, but the protection scope of this application is not limited to this. Any person skilled in the art may easily think of changes or substitutions within the technical scope disclosed in this application, which shall be included in this application. Therefore, the protection scope of this application should be based on the protection scope of the claims.

### Embodiment 5

The application provides a body positioning system.

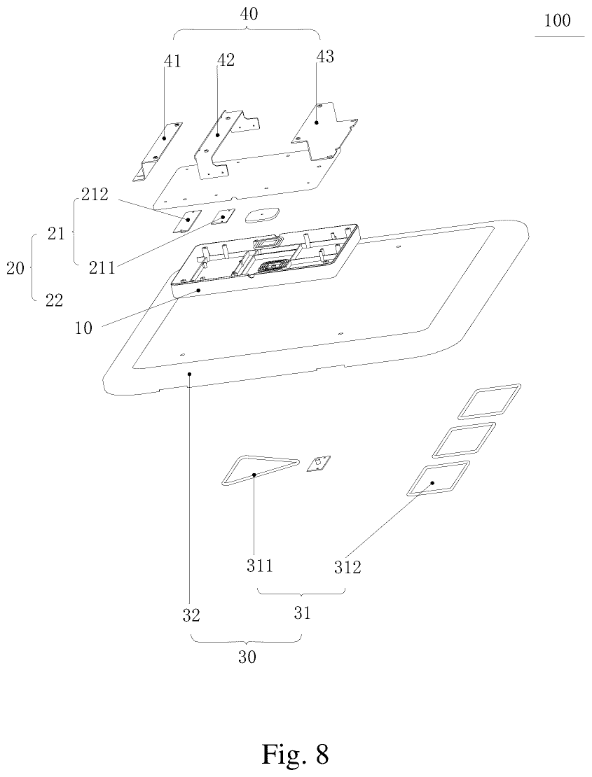

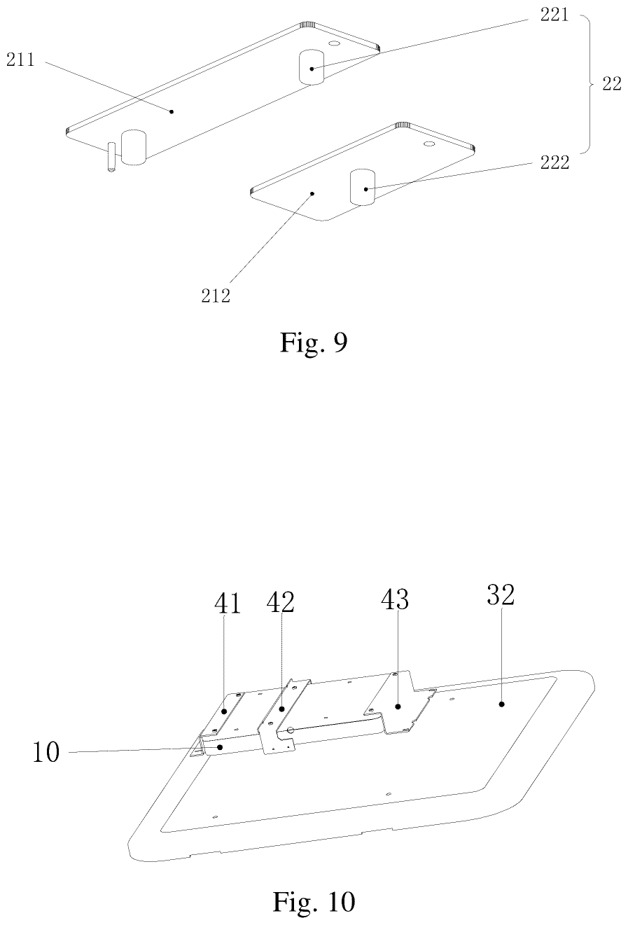

Referring to FIGS. 8 to 10, FIG. 8 is a structural schematic diagram of an embodiment of the body positioning system of the present application; FIG. 9 is a structural diagram of another embodiment of the body positioning system of the present application; FIG. 10 is a structural schematic diagram of another embodiment of the body positioning system of the present application.

In the embodiment of the present application, the body positioning system 100 includes the above-mentioned self-moving equipment. As shown in FIG. 8 to FIG. 10, the self-moving equipment includes the head 1 and the body 2 (each self-moving equipment necessarily includes the head 1 and the body 2, and the body may also be understood as a mobile robot body). The body is provided with an induction assembly 20, and a positioning device 30.

The positioning device 30 includes a base 32 and a coil assembly 31, and the coil assembly 31 is installed on the base 32.

When the position of induction assembly 20 corresponds to the position of coil assembly 31, the induction assembly 20 and the coil assembly 31 induce and locate the position of the body.

It should be understood that in the process of positioning the charging base station and the body, when the charging base station and the infrared sensor on the body are used for inductive positioning, the infrared sensor is greatly affected by the environment and prone to positioning errors, so it is necessary to acquire accurate positioning between the body and the charging base station to ensure the stability and accuracy of automatic charging.

It can be understood that the body is accurately positioned on the base 32, so as to facilitate the accurate connection between the body and the charging base station (understandably, the charging base station must have at least one charging pile for charging, such as the above-mentioned target charging pile), thus the induction assembly 20 is provided on the body. A coil structure capable of induction with the induction assembly 20 is arranged on the base 32, and the accurate positioning of the body on the base 32 is determined by electromagnetic induction, so as to ensure the accuracy of the connection between the body and the charging base station.

According to the technical solution of the application, the body moves to drive the induction assembly 20 to gradually approach the coil assembly 31 on the base 32, and when the induction assembly 20 is facing the coil assembly 31, the coil assembly 31 generates a magnetic field, the induction assembly 20 and the coil assembly 31 are electromagnetically induced to locate the position of the body on the base 32, thus improving the positioning accuracy of the body.

In an embodiment, the induction assembly comprises a magnetic induction sensor. Further, the induction assembly 20 comprises a receiving plate 21 and a plurality of inductors 22, and the first receiving plate 21 is arranged on the side of the body close to the base 32, the plurality of inductors 22 are installed on the side of the receiving plate 21 close to the base 32 at intervals, and are distributed in a triangle shape, and the plurality of inductors 22 are induced with the coil assembly 31 to locate the position of the body. In this embodiment, the position of the body is located by induction between the inductor and the coil assembly 31, and the above working principle is the working principle of the magnetic induction sensor. Thus, the inductor 22 may be regarded as a part of the magnetic induction sensor in the induction assembly, and each inductor corresponds to one magnetic induction sensor.

In an embodiment, the coil assembly is arranged on a target charging pile in a charging base station (understandably, there must be at least one charging pile in the charging base station, such as the target charging pile), and the induction between the target charging pile and the self-moving equipment can generate the positioning inductance through the induction between the coil assembly and the magnetic induction sensor when the positions correspond.

The target charging pile is provided with a coil assembly, and the induction between the target charging pile and the self-moving equipment can specifically generate the positioning inductance through the induction between the coil assembly and the magnetic induction sensor when the positions correspond. In a specific embodiment, the magnetic induction sensor comprises a first magnetic induction sensor and a second magnetic induction sensor; the first magnetic induction sensor may be composed of two magnetic induction sensors, and the second magnetic induction sensor may be composed of one magnetic induction sensor. The first magnetic induction sensor and the second magnetic induction sensor are distributed in a triangle shape, which is convenient to adapt to the induction between the first magnetic induction sensor and the second magnetic induction sensor and the recharging positioning coil, wherein the recharging positioning coil may be a triangular recharging positioning coil. When positioning for recharging the self-moving equipment according to the positioning inductance, it can merely use the first positioning inductance sensed by the first magnetic induction sensor. When the first magnetic induction sensor senses the magnetic field of the recharging positioning coil, and the first positioning inductance is within the preset magnetic induction threshold range, the magnetic inductance of the second positioning inductance is detected from scratch until the second positioning inductance reaches the preset magnetic inductance, thus realizing the accurate positioning for recharging the self-moving equipment.

It can be understood that the receiving plate 21 is used to carry a plurality of the inductors 22.

It can be understood that in order to ensure the accuracy of inductive positioning of the plurality of inductors 22, the magnetic field intensity of the coil assembly 31 is preset, and when the plurality of inductors 22 sense the magnetic field intensity within a limited range, it is determined that the body realizes positioning, and the current of the coil and the number of turns of the coil affect the preset magnetic field intensity.

As shown in FIG. 8, in this embodiment, the plurality of inductors 22 can be electromagnetically induced with the magnetic field generated by the coil assembly 31, and the inductors 22 are distributed in a triangle, and the magnetic field intensity of the magnetic field generated by the coil assembly 31 is induced by the inductors 22 on the triangle, and the induced magnetic field intensity is within a limited range, so as to realize accurate positioning of the body.

It should be noted that the body needs to be accurately positioned on the base 32, and if it is only positioned once, the positioning accuracy is not high. Positioning the body for several times is beneficial to ensuring the positioning accuracy and improving the positioning efficiency.

It can be understood that the coil assembly 31 includes a positioning element 311 and a plurality of beacon elements 312, and the plurality of beacon elements 312 are arranged on the base 32 in parallel and at intervals, and the positioning element 311 is arranged on the base 32 in parallel with one beacon element 312.

As shown in FIG. 8, in this embodiment, the number of the beacon elements 312 is 3 (for example, the left beacon, middle beacon and right beacon mentioned above), and the 3 beacon elements 312 are arranged on the base 32 at intervals and in parallel, and generate magnetic fields, and the generated magnetic fields are different in intensity. The beacon element 312 in the middle is used to determine the initial positioning of the body. When the body moves, the plurality of the inductors 22 move and are close to 3 beacon elements 312. During the movement of the body, sensing the magnetic field intensities of 3 beacon elements 312, when the plurality of inductors 22 sense different magnetic field intensities, or when the magnetic field intensities sensed by the plurality of inductors 22 are not the magnetic field intensities of the beacon element 312 in the middle, the body moves for positioning again, and when the plurality of inductors 22 sense the magnetic field intensities of the beacon element 312 in the middle, the body realizes initial positioning.

It should be understood that there is an interval between two adjacent beacon elements 312, and when the plurality of inductors 22 moves between two adjacent beacon elements 312, the plurality of inductors 22 will not be induced with the beacon elements 312, which requires the body to move constantly, resulting in low positioning effect and efficiency of the body.

It can be understood that the inductor 22 includes a first inductor 221.

The spacing between any two adjacent beacon elements 312 is smaller than the spacing between two adjacent first inductors 221.

The first inductor 221 is induced with both the beacon element 312 and the positioning element 311.

As shown in FIG. 10, in this embodiment, the number of the first inductors 221 is two, and the two first inductors 221 are arranged in parallel and at intervals, and the two first inductors 221 and the second inductor 222 are distributed in a triangle.

As shown in FIG. 10, in this embodiment, the distance between any two adjacent beacon elements 312 is smaller than the distance between two adjacent first inductors 221. When the body moves to drive the two first inductors 221 to approach the three beacon elements 312, at least one of the two first inductors 221 can be electromagnetically induced with one of the beacon elements 312, so as to determine the accuracy of the positioning of the body.

For example, when at most one of the two first inductors 221 is electromagnetically induced with the middle beacon element 312, it is determined that the body needs to be relocated and positioned, and both the first inductors 221 are electromagnetically induced with the middle beacon element 312, and it is determined that the body has achieved initial positioning.

It can be understood that the number of turns of the coil and the current passing through the coil affect the magnetic field intensity of the coil. In order to ensure that there is an obvious limit between the magnetic field intensity inside the coil and the magnetic field intensity outside the coil, and the uniformity of the magnetic field intensity inside the coil, it is necessary to preset the number of turns of the coil and the current.

In an embodiment, the plurality of beacon elements 312 and the positioning element 311 are coil structures.

Preferably, one of the beacon elements 312 is connected to a switch circuit, the number of turns of the positioning element 311 is 2-4, and the number of turns of the beacon element 312 is 2-4.

It should be understood that one of the beacon elements 312 is connected to a switching circuit, and different beacon elements 312 can generate magnetic field intensities of different frequencies by controlling different PWM (Pulse width modulation) controllers, so that the plurality of inductors 22 can sense magnetic field intensities of different frequencies. By taking the preset magnetic field intensity as the initial positioning position, when the plurality of inductors 22 sense the preset magnetic field intensity, the initial positioning of the body is realized.

It should be understood that the number of coil turns of the positioning element 311 is 2-4, and preferably, the number of coil turns of the positioning element 311 is 3, so as to ensure that there is an obvious limit between the magnetic field intensity inside the coil and the magnetic field intensity outside the coil, and the uniformity of the magnetic field intensity inside the coil.

It should be understood that the number of turns of the beacon element 312 is 2-4, and preferably, the number of turns of the beacon element 312 is 3, so as to ensure that there is an obvious limit between the magnetic field intensity inside the coil and the magnetic field intensity outside the coil, and the magnetic field intensity inside the coil is uniform.

In an embodiment, the inductor 22 further includes a second inductor 222. The receiving plate 21 comprises a first plate 211 and a second plate 212, and a plurality of the first inductors 221 are installed on the first plate 211, the second inductors 222 are installed on the second plate 212, and the plurality of the first inductors 221 and the second inductors 222 are distributed in a triangle.

The second inductor is induced with the positioning element 311.

As shown in FIG. 8, in this embodiment, the first plate 211 and the second plate 212 are arranged at intervals, and two first inductors 221 are arranged at intervals on the first plate 211. By adjusting the interval between the first plate 211 and the second plate 212, the size of two triangles formed by the first inductor 221 and the second inductor 222 are adjusted, so as to adapt to the induction with the coil of the positioning element 311 and ensure the accurate positioning of the body.

In an embodiment, the plurality of firsts inductor 221 are all induced with the beacon element 312 arranged in parallel with the positioning element 311, and the position of the body is located for the first time.

As shown in FIG. 8, in this embodiment, 3 beacon elements 312 and positioning element 311 are distributed in a “T” shape on the base 32.

In this embodiment, the plurality of first inductors 221 are all induced with the beacon element 312 arranged in parallel with the positioning element 311, that is, a plurality of the first inductors 221 are electromagnetically induced with the beacon element 312 in the middle. So as to realize the initial positioning of the body, and because the positioning element 311 and the middle beacon element 312 are arranged at intervals and in parallel, the initial positioning of the body is realized, and the body is moved so that the plurality of inductors are close to the positioning element 311, which is beneficial to realizing the accurate positioning of the body and improving the positioning accuracy and efficiency of the body.

In an embodiment, the coil of the positioning element 311 is triangular, and the plurality of the first inductors 221 and the second inductors 222 are correspondingly induced in the coil of the positioning element 311, and the position of the body is positioned for the second time.

In this embodiment, the second inductor 222 and the two first inductors 221 are triangularly distributed, which facilitates the induction between the second inductor 222 and the two first inductors 221 and the triangular positioning coil. The second inductor 222 and the two first inductor 221 both sense the magnetic field of the positioning element 311, and the intensity range of the sensed magnetic field is within a limited range, so as to realize the secondary accurate positioning of the body through triangulation.

It should be noted that the sensing range of the first inductor 221 diverges around the first inductor 221, so the sensing range of the first inductor 221 is a circular area. The induction range of the second inductor 222 diverges around the center of the second inductor 222, so the induction range of the second inductor 222 is a circular area, the diameter of the circular induction range of the first inductor 221 is 20-50 mm, and the diameter of the circular induction range of the second inductor 222 is 20-50 mm.

It can be understood that in this embodiment, when both the first inductor 221 and the second inductor 222 are induced with the positioning element 311 of the triangle, the sensing ranges of the two first inductors 221 are inscribed with an angle of the positioning element 311 of the triangle, and the sensing range of the second inductor 222 is inscribed with an angle of the positioning element 311 of the triangle, thereby completing the secondary accurate positioning of the body.

In an embodiment, the housing 10 is installed on the side of the body near the base 32, the induction assembly 20 is arranged in the housing 10, and the distance between the inductor 22 and the coil assembly 31 is 60-80 mm.

In this embodiment, the body 50 carries the induction assembly 20, so that the distance between the induction assembly 20 and the coil assembly 31 is 60-80 mm. Preferably, the distance between the induction assembly 20 and the coil assembly 31 is 70 mm, so that when the inductor 22 is electromagnetically induced with the positioning element 311 or the beacon element 312, the induction can be accurately and clearly captured, which is beneficial to ensuring the sensitivity and accuracy of induction of the plurality of inductors.

In order to ensure the connection between the housing 10 and the body, this embodiment further includes a connecting mechanism 40, which further includes a first connector 41, a second connector 42 and a third connector 43. The first connector 41, the second connector 42 and the third connector 43 are arranged on the surface of the housing 10 at intervals and connected with the body.

As shown in FIGS. 8 and 9, in this embodiment, the first connector 41, the second connector 42 and the third connector 43 are all metal folding pieces. The first connector 41 and the third connector 43 are respectively arranged at two opposite ends of the housing 10, and the second connector 42 is connected with the middle part of the surface of the housing 10. Through the first connector 41, second connector 42 and third connector 43, the housing 10 is firmly installed on the side of the body close to the base 32. In this way, when the induction assembly 20 faces the coil assembly 31, the separation distance between the induction assembly 20 and the coil assembly 31 will not change greatly, thus ensuring that the accuracy and sensitivity of induction among the plurality of inductors 22 and the beacon element 312 or the positioning element 311, so as to ensure the accuracy of the positioning of the body.

The application also provides a body charging device, which comprises a body positioning system 100 and a charging system. The specific structure of the body positioning system 100 can refer to the above embodiments. As the body charging device adopts all the technical solutions of all the above embodiments, it has at least all the beneficial effects brought by the technical solutions of the above embodiments, which will not be repeated here. The charging system comprises a sending module and a receiving module. The sending module is arranged at one side of the base 32, and the sending module and the positioning device 30 are arranged at intervals; the receiving module is arranged at the bottom of the body.

In this embodiment, the body is initially positioned relative to the beacon element 312 in the middle of the base 32, and after the second accurate positioning relative to the positioning element 311, the receiving module of the body is induced with the sending module on the base 32, and the body is charged. The positioning device 30 and the sending module constitute a charging base station.

### Embodiment 6

An embodiment of the present application provides a computer-readable storage medium with computer-readable program instructions stored thereon, which are used for executing the positioning method for recharging in Embodiment 1.

The computer-readable storage medium provided by the embodiment of the present application may be, for example, a U disk, but is not limited to an electric, magnetic, optical, electromagnetic, infrared, or semiconductor system, system or device, or any combination thereof. More specific examples of computer-readable storage media may include, but are not limited to, an electrical connection with one or more wires, a portable computer disk, a hard disk, RAM (Random Access Memory), read only memory (ROM), erasable programmable read only memory (EPROM), optical fiber, portable compact disk read only memory (CD-ROM), optical storage device, magnetic storage device, or any suitable combination of the above. In this embodiment, the computer-readable storage medium may be any tangible medium containing or storing a program, which can be used by or in combination with an instruction execution system, system or device. The program code contained in the computer-readable storage medium can be transmitted by any suitable medium, including but not limited to: wires, optical cables, RF (Radio Frequency), etc., or any suitable combination of the above.

The computer-readable storage medium may be included in an electronic device. It may also exist alone without being assembled into electronic equipment.

The computer-readable storage medium carries one or more programs, and when the one or more programs are executed by the electronic equipment, the electronic equipment can acquire the positioning inductance on a recharging path through the magnetic induction sensor, wherein the recharging path refers to the path that the mobile equipment moves to the target charging pile. The self-moving equipment is positioned for recharging according to the positioning inductance.

Computer program codes for performing the operations of the present disclosure may be written in one or more programming languages or combinations thereof, including object-oriented programming languages such as Java, Smalltalk, C++, and conventional procedural programming languages such as “C” or similar programming languages. The program code may be completely executed on the user's computer, partially executed on the user's computer, executed as a separated software package, partially executed on the user's computer and partially executed on a remote computer, or completely executed on a remote computer or server. In the case involving a remote computer, the remote computer may be connected to a user computer through any kind of network, including LAN (Local Area Network) or WAN (Wide Area Network), or may be connected to an external computer (for example, through the Internet using an Internet service provider).

The flowcharts and block diagrams in the drawings illustrate the architecture, functions and operations of possible implementations of systems, methods and computer program products according to various embodiments of the present application. In this regard, each block in the flowchart or block diagram may represent a module, a program segment, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, may be implemented by a dedicated hardware-based system that performs specified functions or operations, or by a combination of dedicated hardware and computer instructions.

The modules described in the embodiments of the present disclosure can be realized by software or hardware. The name of the module does not constitute the limitation of the unit itself in some cases.

The readable storage medium provided by the application is a computer-readable storage medium, and the computer-readable storage medium stores computer-readable program instructions for executing the positioning method for recharging, which can solve the technical problem of large positioning error in the recharging positioning process for the existing self-moving equipment, so that the recharging positioning accuracy of the self-moving equipment will not be reduced. Compared with the prior art, the beneficial effects of the computer-readable storage medium provided by the embodiment of the present application are the same as those of the positioning method for recharging provided by Embodiment 1 or Embodiment 2, and are not repeated here.

### Embodiment 7

The embodiment of the application also provides a computer program product, including a computer program, which, when executed by a processor, realizes the steps of the positioning method for recharging as described above.

The computer program product provided by the application can solve the technical problem that the existing self-moving equipment is prone to large positioning errors and reduced positioning accuracy due to the interference caused by complex environmental factors during the recharging positioning process. Compared with the prior art, the computer program product provided by the embodiment of the present application has the same beneficial effects as the positioning method for recharging provided by Embodiment 1 or Embodiment 2, which will not be repeated here.

It should be noted that in the present application, the terms “comprising”, “including”, or any other variation thereof are intended to cover non-exclusive inclusion, so that a process, method, article or system including a series of elements includes not only those elements, but also other elements not explicitly listed, or elements inherent to such process, method, article or system. Without more limitations, an element defined by the phrase “comprising one” does not exclude the existence of other identical elements in the process, method, article or system that includes the element.

The above serial numbers of the embodiments of the present application are only for description, and do not represent the superiority of the embodiments.

Through the description of the above embodiments, those skilled in the art can clearly understand that the methods of the above embodiments can be realized by means of software and necessary general hardware platform, and of course they can also be realized by hardware, but in many cases, the former is the better embodiment. Based on this understanding, the technical solutions of the present application may be embodied in the form of a software product, which is stored in a storage medium (such as ROM/RAM, magnetic disk, optical disk, etc.) and include several instructions to make a terminal device (which may be a mobile phone, a computer, a server, or a network device, etc.) execute the methods described in the above embodiments of the present application.

The above are merely preferred embodiments of this application, not intended to limit the patent scope of this application. Any equivalent structure or equivalent process transformation made by using the contents of this application specification and drawings, or directly or indirectly used in other related technical fields, are included in the patent protection scope of this application by the same logic.

1. A positioning method for recharging, applied to a self-moving equipment; a positioning inductance is generated by induction between the self-moving equipment and a target charging pile, and the self-moving equipment is provided with a magnetic induction sensor, wherein the positioning method for recharging comprises:
acquiring the positioning inductance on a recharging path through the magnetic induction sensor, the recharging path refers to a path that the self-moving equipment moves to the target charging pile; and
positioning the self-moving equipment for recharging according to the positioning inductance.

2. The positioning method for recharging of claim 1, wherein the positioning inductance comprises a preset positioning inductance and a recharging positioning inductance,
the step of positioning the self-moving equipment for recharging according to the positioning inductance comprises:
detecting whether the beacon that the self-moving equipment currently located is a middle beacon, and the currently-located beacon is arranged in the target charging pile;
if the currently-located beacon is the middle beacon, positioning the self-moving equipment for recharging according to the recharging positioning inductance;
if the currently-located beacon is not the middle beacon, the self-moving equipment moves according to the preset positioning inductance until the self-moving equipment arrives at the middle beacon.

3. The positioning method for recharging of claim 1, wherein the step of positioning the self-moving equipment for recharging according to the positioning inductance comprises:
detecting whether the positioning inductance reaches a preset magnetic induction threshold;
if yes, determining that the positioning of the self-moving equipment for recharging is complete;
if not, adjusting a position of the self-moving equipment to obtain an adjusted position;
taking a magnetic inductance induced by the magnetic induction sensor at the adjusted position as the positioning inductance, and returning to execute the step: detecting whether the positioning inductance reaches a preset magnetic induction threshold.

4. The positioning method for recharging of claim 3, wherein the target charging pile is provided with a coil assembly, and when positions correspond, the magnetic induction sensor and the coil assembly are induced to generate the positioning inductance, wherein the magnetic induction sensor comprises a first magnetic induction sensor and a second magnetic induction sensor, and the first magnetic induction sensor and the second magnetic induction sensor are distributed in a triangle; the positioning inductance comprises a first positioning inductance induced by the first magnetic induction sensor and a second positioning inductance induced by the second magnetic induction sensor,
the step of positioning the self-moving equipment for recharging according to the positioning inductance comprises:
detecting the second positioning inductance when the first positioning inductance reaches the preset magnetic induction threshold;
according to sizes of the second positioning inductance and the preset magnetic induction threshold, iteratively adjusting the position of the self-moving equipment until the second positioning inductance reaches the preset magnetic induction threshold.

5. The positioning method for recharging of claim 2, wherein before the step of acquiring the positioning inductance on a recharging path through the magnetic induction sensor, the positioning method for recharging further comprises:
detecting whether a first obstacle exists between the target charging pile and the self-moving equipment through a preset sensor in the self-moving equipment;
if the first obstacle exists, when detecting that the first obstacle is a movable obstacle, determining whether to move the movable obstacle;
if the first obstacle does not exist, controlling the self-moving equipment to move to a first preset position;
detecting whether a second obstacle exists on a recharging positioning surface of the target charging pile at the first preset position;
if the second obstacle exists, cleaning the second obstacle, and after the cleaning is completed, determining whether the recharging positioning surface meets recharging positioning conditions by performing detection on the recharging positioning surface again.

6. The positioning method for recharging of claim 5, wherein the step of detecting whether a second obstacle exists on a recharging positioning surface of the target charging pile at the first preset position comprises:
acquiring real-time body data corresponding to the recharging positioning surface of the target charging pile at the first preset position;
extracting historical body data corresponding to the recharging positioning surface, wherein the historical body data refers to the body data of the self-moving equipment when the second obstacle does not exist on the recharging positioning surface; and
determining whether the second obstacle exists on the recharging positioning surface of the target charging pile by comparing the real-time body data with the historical body data.

7. The positioning method for recharging of claim 1, wherein the positioning method for recharging further comprises:
acquiring a communication situation between the self-moving equipment and the target charging pile;
if the communication situation is abnormal, acquiring the positioning inductance on the recharging path through the magnetic induction sensor after the self-moving equipment is located the first preset position, and determining whether the target charging pile has moved;
if it is determined that the target charging pile has moved, controlling the self-moving equipment to move to a second preset position where the preset charging pile is currently located; and
detecting whether an alternative charging pile exists in a preset communication range, and controlling the self-moving equipment to move to the alternative charging pile after determining that the alternative charging pile exists in the preset communication range.

8. A self-moving equipment, wherein the self-moving equipment comprises a head, a body, a recharging positioning equipment, a memory, a processor and a recharging positioning program for the self-moving equipment stored in the memory and executable on the processor, wherein the head is detachably connected to the body, the recharging positioning equipment, the memory and the processor are arranged on the body, and the recharging positioning program for the self-moving equipment is configured to realize the positioning method for recharging of claim 1.

9. A body positioning system, wherein the body positioning system comprises the self-moving equipment of claim 8, the self-moving equipment comprising the head and the body; the body is provided with an induction assembly;
the body positioning system further comprises a positioning device, wherein the positioning device comprises a base and a coil assembly, and the coil assembly is installed on the base; and
when a position of the induction assembly corresponds to a position of the coil assembly, the induction assembly and the coil assembly are induced to locate a position of the body.

10. The body positioning system of claim 9, wherein the induction assembly comprises a magnetic induction sensor.

11. The body positioning system of claim 10, wherein the magnetic induction sensor comprises a first magnetic induction sensor and a second magnetic induction sensor, and the first magnetic induction sensor and the second magnetic induction sensor are distributed in a triangle.

12. The body positioning system of claim 10, wherein the coil assembly is arranged on a target charging pile in a charging base station, and induction between the target charging pile and the self-moving equipment generates a positioning inductance through induction between the coil assembly and the magnetic induction sensor when the positions correspond.

13. The body positioning system of claim 9, wherein the induction assembly comprises a receiving plate and a plurality of inductors, the receiving plate is arranged on a side of the body near the base, the plurality of inductors are installed on a side of the receiving plate near the base at intervals, the plurality of inductors are distributed in a triangle, and are induced with the coil assembly to locate the position of the body.

14. The body positioning system of claim 13, wherein the coil assembly comprises a positioning element and a plurality of beacon elements, wherein the plurality of beacon elements are arranged in parallel on the base at intervals, and the positioning element is arranged on the base and is arranged in parallel with one beacon element.

15. The body positioning system of claim 14, wherein the inductor comprises a first inductor;
a space between any two adjacent beacon elements is smaller than that between two adjacent first inductors; and
the first inductor is induced with both the beacon element and the positioning element.

16. The body positioning system of claim 14, wherein the plurality of the beacon elements and the positioning element are in coil structures, and the number of turns in the positioning element coil is 2-4, and the number of turns in the beacon element coil is 2-4.

17. The body positioning system of claim 15, wherein the inductor further comprises a second inductor; the receiving plate comprises a first plate and a second plate, the plurality of first inductors are installed on the first plate, and the second inductors are installed on the second plate, and the plurality of first inductors and the second inductor are distributed in a triangle; the second inductor is induced with the positioning element.

18. The body positioning system of claim 17, wherein the plurality of the first inductors are all induced with the beacon element arranged in parallel with the positioning element, and are used for positioning the position of the body for the first time.

19. The body positioning system of claim 17, wherein the positioning element coil is triangular, and the plurality of first inductors and the second inductor are induced with the positioning element coil for positioning the position of the body for the second time.

20. The body positioning system of claim 17, wherein a housing is installed on a side of the body near the base, the induction assembly is arranged in the housing, and an induction distance between the inductor and the coil assembly is 60-80 mm.
